(19) United States
(12) Patent Application Publication
(10) Pub. No.: US 2018/0251881 A1
(43) Pub. Date: Sep. 6, 2018

(54) CERAMIC COATING DEPOSITION

(71) Applicant: United Technologies Corporation, Farmington, CT (US)

(72) Inventor: Brian T. Hazel, Avon, CT (US)

(73) Assignee: United Technologies Corporation, Farmington, CT (US)

(21) Appl. No.: 15/449,129

(22) Filed: Mar. 3, 2017

(51) Int. Cl. C23C 4/134; C23C 4/11; F01D 5/28; F01D 9/02; F01D 11/08; F23R 3/00

(52) U.S. Cl. CPC C23C 4/134; C23C 4/11; F01D 5/288; F01D 9/02; F05D 2300/211; F23R 3/002; F05D 2220/32; F05D 2230/90; F01D 11/08

(57) ABSTRACT

A ceramic coating process comprises introducing a suspension including a fine ceramic particulate suspended in a liquid carrier into a plasma torch. The fine ceramic particulate comprising a first material having high toughness and a second material having a beneficial reaction in combination with calcium-magnesium alumino-silicates. The method includes melting the fine ceramic particulate in the plasma torch; propelling the fine ceramic particulate toward a substrate; and forming a coating on the substrate. The coating comprises splats of the fine ceramic particulate.

### BACKGROUND

The present disclosure relates generally to methods for coating a surface and more particularly is directed to a ceramic coating process.

Suspension Plasma Spray (SPS) is a coating process for ceramic thermal barrier coatings (TBC) that makes a columnar shaped structure by means of a plasma spray process. The columnar shapes are composed of fine ceramic particles with fine dispersed porosity instead of epitaxial growth of a single crystal in the case of electron beam physical vapor deposition (EBPVD).

One result of the SPS column structure is a column toughness less than EB-PVD as measured by ASTM C633 tensile bond. It is believed the dispersed porosity is the largest factor reducing the column toughness but the grain boundaries between particles may also contribute.

Tests have been conducted where calcium-magnesium alumino-silicates (CMAS) material originating from siliceous debris was injected into the air inlet of a gas turbine engine to determine the damage rate in CMAS attack for SPS coating. It was found that the CMAS infiltrated faster in SPS (believed to be due to the higher intra-columnar porosity and grain boundaries) and also the coating shed in layers more quickly than expected with EB-PVD. One change that may benefit the SPS CMAS resistance is to increase the column toughness.

Possibilities exist to circumvent these drawbacks through the use of a carrier medium by which powders containing gadolinium zirconate (GdZ) and yttria stabilized zirconia (YSZ) can be brought to the thermal spray torch and injected into the high energy gas flow of the thermal spray torch to form multi-material layers with the materials mixed at the individual particle size scale.

### SUMMARY

In accordance with the present disclosure, there is provided a ceramic coating process comprising introducing a suspension including a fine ceramic particulate suspended in a liquid carrier into a plasma torch, comprising at least one of co-spraying at least two suspensions composed of dissimilar fine ceramic particulate at least one of simultaneously and in series; spraying a single suspension composed of dissimilar fine ceramic particulate, and co-spraying at least one suspension composed of fine ceramic particulate and at least one dry powder into the plasma torch, wherein the dry powder is larger than the fine ceramic particulate, the fine ceramic particulate comprising a first material having high toughness and a second material having a beneficial reaction in combination with calcium-magnesium alumino-silicates; forming at least one liquid droplet, the at least one liquid droplet comprising a plurality of the fine ceramic particulate wherein the fine ceramic particulate comprises a submicron size; vaporizing the liquid carrier in the plasma torch; and agglomerating the plurality of fine ceramic particulate into a single particulate; melting the agglomerated fine ceramic particulate in the plasma torch; propelling the melted fine ceramic particulate toward a substrate; forming a coating on the substrate, the coating comprising splats of the fine ceramic particulate.

In another and alternative embodiment the first material comprises YSZ and the second material comprises Gd₂Zr₂O₇.

In another and alternative embodiment the first material comprises at least one of a lanthanide series and Sc substituted partially or completely for Y.

In another and alternative embodiment the second material comprises 51-99 mol % GdO_{1.5} and balance ZrO₂.

In another and alternative embodiment the second material comprises Gd₂O₃.

In another and alternative embodiment at least one of said first and said second material comprises at least one of any lanthanide series, Y, and Sc substituted partially or completely for Gd.

In another and alternative embodiment the second material comprises at least one of Hf and Ti substituted at least partially or completely for Zr.

In accordance with the present disclosure, there is provided an article comprising a substrate having a surface; and a coating system coupled to the surface, the coating system comprising a structure, the structure comprising a series of individual splats formed from agglomerated fine ceramic particulate, the agglomerated fine ceramic particulate consisting of a first material of YSZ and a second material of 20-100 mol % GdO_{1.5} balance ZrO₂, wherein the series of individual splats comprises at least one of similar fine ceramic particulate and at least two dissimilar fine ceramic and dry powder particles introduced from dry powders; wherein the dry powder particles are larger than the fine ceramic particulate.

In another and alternative embodiment the fine ceramic particulate includes a co-spray of a first suspension of YSZ and a second suspension of from about 20-70 mol % gadolinia balance zirconia.

In another and alternative embodiment the first material comprises at least one of a lanthanide series and Sc substituted partially or completely for Y.

In another and alternative embodiment the second material comprises 51-99 mol % GdO_{1.5} and a balance ZrO₂.

In another and alternative embodiment the second material comprises Gd₂O₃.

In another and alternative embodiment the second material comprises at least one of any lanthanide series, Y, and Sc substituted partially or completely for Gd.

In another and alternative embodiment the at least one of the first and the second material comprises at least one of Hf and Ti substituted at least partially or completely for Zr.

In another and alternative embodiment the structure comprises at least one of a porous structure, a dense structure having vertical cracks, a near fully dense structure, and a columnar structure.

Other details of the ceramic coating process are set forth in the following detailed description and the accompanying drawing wherein like reference numerals depict like elements.

### BRIEF DESCRIPTION OF THE DRAWINGS

FIG. 1 is a partially schematic sectional view of substrate having a coating.

FIG. 2 is a partially schematic view of an apparatus for applying the coating to the substrate.

### DETAILED DESCRIPTION

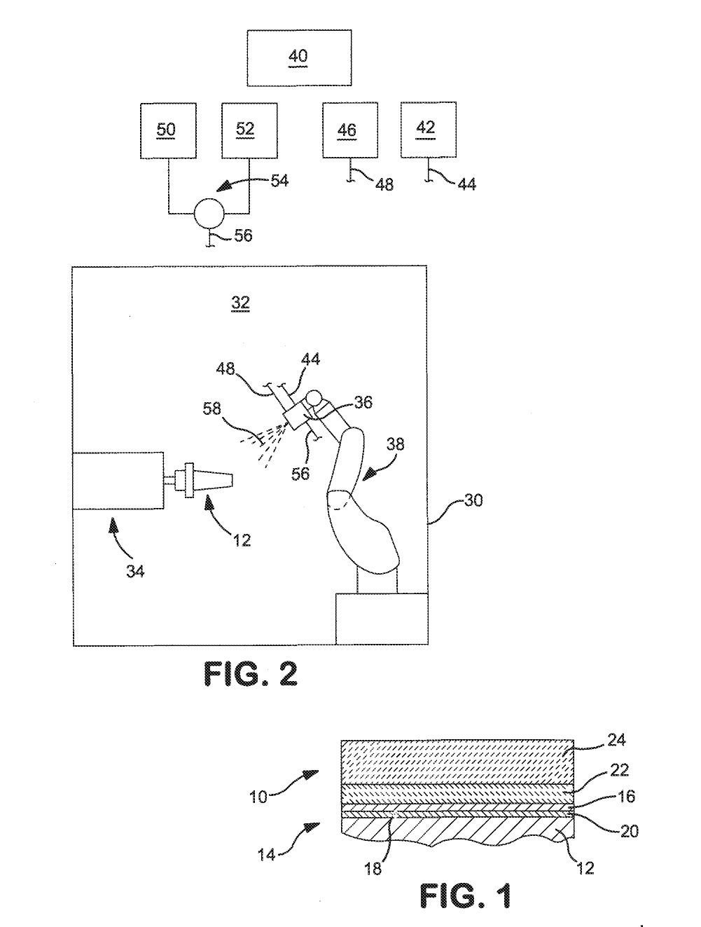

Referring now to FIG. 1 shows a coating system 10 atop a metallic substrate 12. In an exemplary embodiment, the substrate is a nickel-based superalloy or a cobalt-based superalloy such as a cast article or component 14 (e.g., a nickel-based single crystal casting) of a gas turbine engine. Exemplary components 14 are hot section components such as combustor panels, turbine blades, turbine vanes, and blade outer air seals.

The coating system 10 may include a bondcoat 20 layered on a surface 18 of the substrate 12. In an exemplary embodiment, the bondcoat 20 can be a metallic bondcoat. The bond coat 20 can embody a variety of thicknesses. One exemplary bond coat 20 thicknesses is in the range of 2 to 500 micrometers. Another exemplary bond coat 20 thickness is in the range of 12 to 250 micrometers. Yet another exemplary bond coat 20 thickness is in the range of 25 to 150 micrometers.

An interfacial layer 16 can be optionally formed at the interface of the bondcoat 20 and a first layer 22. The interfacial layer 16 can include a thermally grown oxide layer in an exemplary embodiment.

In an exemplary embodiment, the coating system 10 can include a single layer or in alternative embodiments a multi-layer system with at least two layers. The first layer 22 is a lower layer. A second layer 24 is over the first layer 22. The first layer 22 can have different physical properties than the second layer 24.

The first layer 22 and second layer 24 can be applied to the component 14 using the same application technique and same equipment. An exemplary application technique includes a suspension plasma spray (SPS) technique. The SPS technique enables a mixture of dissimilar compositions on a fine scale that form a coating composition of multi-component ceramics.

FIG. 2 is an exemplary apparatus for coating the substrate. FIG. 2 shows an exemplary chamber 30 having an interior 32 containing one or more substrates 12 held by a substrate holder 34 (which may hold the substrate(s) stationary or may move them (e.g., via rotation)). Alternative implementations may involve open-air spraying (without any chamber separate from the factory room in which spraying occurs). Exemplary spraying is at atmospheric pressure (e.g., nominally 101.3 kPa and usually at least 95 kPa). To perform the SPS process, the chamber contains a thermal spray gun 36. In the exemplary implementation, the gun is carried by an industrial robot 38. The gun, robot, substrate holder, and other controllable system components may be controlled via a controller 40 (e.g., a microcontroller, microcomputer, or the like) coupled to various system components and sensors and input/output devices. The controller 40 may have a processor, memory, and/or storage containing instructions for controlling operations such as discussed below. Communication with various controlled systems, sensors, and input/output devices may be via hardwiring or wireless communications. The controlled systems may further include a gun power source 42 coupled to the gun 36 via an electrical line 44, a gas source 46 coupled to the gun 36 via a gas line 48, and one or more coating material sources (an exemplary two: a first material source 50 and a second material source 52 being shown). Exemplary coating sources 50, 52 are coupled via a controllable valve 54 to a line 56 extending to the gun. The exemplary sources 50 and 52 respectively provide the first and second coating layers 22, 24. However, other configurations are possible including separate sources coupled to separate guns. In an alternative embodiment, there can be two separate sources supplied in separate feed lines and sprayed by separate nozzles in a single gun. There is no limit to the number of coating sources. FIG. 2 further shows the spray 58 discharged from the gun 36.

The gun 36 may be formed as an otherwise conventional spray plasma source with gas comprising an exemplary argon-helium, argon-hydrogen, or argon-hydrogen-nitrogen mixture. The suspension is injected into a plasma being discharged from the gun (via internal or external feed). As the spray passes from the point of injection to the substrate, the spray fragments into droplets (e.g., having a characteristic size in the vicinity of 3 micrometers at some point). Upon penetration in the plasma jet, drops or liquid jets are subjected to a strong shear stress due to the plasma flow which fragment them into smaller droplets, and are exposed to a very high heat flux that vaporizes the liquid of the suspension. During further traversal, the carrier tends to evaporate leading to agglomeration of the particles previously within the droplet and finally followed by melting of such agglomerated clusters of particles to form respective melt droplets which impact the substrate as splats.

In one exemplary SPS technique, a feedstock is dispersed as a suspension in a fluid, such as ethanol, and the fluid is injected wet into the gas stream. Splat sizes in the SPS technique with micron or submicron powder feedstock may be about ½ micron to about 3 microns in diameter and may include thicknesses of less than a micron. The resulting deposited layers have microstructural features that are much smaller than conventional plasma sprayed microstructures.

In one exemplary SPS technique, a polycrystalline coating is characterized by vertically oriented columns separated by vertical cracks or defined gaps. The column diameter is such that the coating is characterized by greater than 100 gaps per inch (40 gaps/cm), more narrowly >80 gaps/cm or 80-400 gaps/cm (characteristic “diameters” being the inverse thereof)). The coating typically contains porosity ranging from 10 to 40% by volume, more particularly 15% to 30% by volume.

The exemplary implementation is performed via the first source 50. The exemplary first and second sources 50, 52 are liquid suspension feed systems. They store or have another supply of a suspension including a carrier such as ethanol with coating particles and dispersant. Exemplary coating particles are submicron particles in the vicinity of 300-1000 nanometers, more broadly, 50-2000 nanometers or 10-5000 nanometers at a weight concentration of 5-50% (more narrowly, 10-30 wt %). The exemplary dispersant is phosphate ester at a weight-concentration of 0.1-2%.

After application of the first layer, the second layer 24 is then applied. Exemplary application of the second layer 24 is performed in the same chamber as the application of the first layer 22. In particular embodiments, it is also via SPS and, more particularly, SPS using the same spray gun as was used in applying the first layer. This may be done by simply switching the powder being delivered to the gun 36 via one or more valves such as 54 switching from the first source 50 to the second source 52.

The exemplary embodiment of spraying the first layer 22 of one composition, such as material from material source 50, then changing and spraying a second composition from another material source 52 can be repeated to make a layered structure. This method limits the thickness of the individual layers primarily because it takes time to change from one injection material to the next.

A first example can include the application of a single layer of YSZ (7-8 wt % yttria stabilized zirconia) which is applied directly to the surface 18 of the substrate 12, alternatively applied to the bondcoat 20 to form the first layer 22, then a single layer of GdZ (gadolinium zirconate) is applied as a second layer 24 over the first layer 22.

Gadolinium zirconate, Gd₂Zr₂O₇ (GdZ) is used as the top layer in SPS and EB-PVD ceramics due to its ability to react beneficially with CMAS. However, gadolinium zirconate, (GdZ) has substantially lower inherent toughness than yttria stabilized zirconia (YSZ) that is used between the GdZ top second layer 24 and the underlying bondcoat 20 and/or interfacial layer 16.

The thickness of individual layers can be changed by increasing the number of passes per layer or changing the solids loading on the suspension. Similarly the ratio of one layer to the other can be changed by the same methods. So, for example the first layer 22, can be twice the thickness as the second layer 24, vice versa and other combinations of ratios of thickness can be accomplished. A range for individual layers could be as low as ˜1 micron, with no upper limit.

In another exemplary embodiment, the method can include a co-spray of two dissimilar suspensions simultaneously or in series. This method mixes the materials at the individual injection droplet size. A droplet includes more than one particle and is thus larger than a particle. In an exemplary embodiment, the gun 36 includes two injection points oriented in a radial fashion relative to the plasma source. The two injection points can be positioned at about 90° to each other separated from each other. In other exemplary embodiments the two injection points can be positioned at various radial angles. The injection points create two injection streams with a cross-over point at the center of the plasma flow. The structure that results from this embodiment, can constitute a single layer composed of many individual splats of dissimilar materials. In an alternative coating, an under-layer could be applied, comprising a homogeneous material, such as YSZ, with a layer of the co-sprayed dissimilar suspensions simultaneously applied over the under-layer. In another exemplary embodiment, an over-layer could be applied over the layer of the co-sprayed dissimilar suspensions simultaneously applied.

As an example, the process includes a co-spray of a first suspension of YSZ and a second suspension of 20-70 mol % gadolinia balance zirconia. Both streams are injected at an equal rate. With the level of gadolinia at an amount as high as 70 mol % in the second suspension, about ⅓ of the coating can include YSZ and have a similar total rare earth (RE) content (where RE rare earth content is defined as a sum of GdO_{1.5} and YO_{1.5} in mol %) as the GdZ material. In another alternative embodiment the second suspension can include 51-99 mol % GdO_{1.5} and balance ZrO₂. In another exemplary embodiment, the second suspension can include a composition with Gd₂O₃ (100 mol % GdO_{1.5}).

The coating composition of high GdZ composition can be anything within the flourite or pyrochlore phase field of the ZrO₂—GdO_{1.5} phase diagram in the about 1200-1400° C. range. The range of these phases have a composition of about 20-70 mol % GdO_{1.5}. These phases, fluorite and phyrochlore, are compatible with the tetragonal phase field represented by YSZ at these elevated temperatures.

In another exemplary embodiment, Gd₂O₃ is used in place of GdZ in the second suspension. If pure Gd₂O₃ is utilized, then the YSZ content in the coating can be up to about 50% with the same RE content as the GdZ material. The use of higher concentration gadolinia material allows for more space in the coating to be filled by the tougher YSZ while maintaining a similar total RE content. Thus, the layer can possess both the CMAS reaction capacity resulting from the total RE content as well as improved toughness from the higher toughness YSZ material.

Although two examples have been provided, it is contemplated that any composition in the continuum of higher GdO_{1.5} with YSZ can be utilized in the coating. The coating can include up to about 70% GdO_{1.5} which has the benefit that fluorite phase field is compatible with YSZ, which limits reaction between the materials but does not maximize YSZ phase content. Having a pure Gd₂O₃ is reactive with YSZ (will react to form fluorite phase) but has the advantage that it maximizes the total amount of tough phase that assumes cubic GdZ and cubic Gd₂O₃ have similarly low toughness.

In alternative exemplary embodiments, other rare earth (RE's) materials can be substituted partially or completely for Gd. Those substitutes can include any of the lanthanides, Sc, or Y or any combinations thereof. In exemplary alternatives, Hf and/or Ti can be substituted partially or completely for Zr. Also GdO_{1.5} can be substituted with any other material that also reacts beneficially with CMAS but has low toughness. YSZ can be substituted with other material that has high toughness.

Deployment of the co-spray process allows varying the thickness of individual layers by changing the solids loading or the choice of liquid carrier. This is due in part because the liquid carrier breakup physics defines the individual droplet size and therefore the layer size. Furthermore, the ratio of individual layers can be changed by changing the feed rate for each separate injection, the solids loading of each suspension, and the choice of liquid carrier of each suspension. Individual layers can be as low as ˜0.1 micron.

In these exemplary methods, the morphology of one material's splats may be varied from the other material by selecting materials with significantly different melting points and tailoring the plasma parameters to only one of these materials. This could mean that one material forms typical splats as shown in these examples but the other material does not undergo significant melting and retains near its original particle shape. In an exemplary embodiment, a boundary can be formed between the particles, between the splats and between the splats and particles. These boundaries can be described as a compositional boundary and a structural boundary. A structural boundary is generally a physical feature in the coating such as the porosity or a lack of complete bonding. The boundary can impact the properties of the coating, such as thermal properties.

In another exemplary embodiment, the process can include spraying of a single suspension composed of dissimilar particles. This method mixes the materials at the individual particle size. Since multiple particles make up a single injection droplet, then this method could generate layering at a finer scale than the exemplary process described above.

Another example of spraying a single suspension composed of dissimilar particles includes spraying a mixed suspension including YSZ and higher concentrations of gadolinia. Both can be injected at an equal rate.

Within the process of spraying of a single suspension composed of dissimilar particles, the thickness of individual layers can be tailored by changing the total solids loading and the particle size. Furthermore, the ratio of individual layers can be changed by changing the solids loading of each material and the particle size for each material. For example, the suspension particle size can be varied from 10s of nm to a few microns. The thickness of individual layers can be below 0.1 micron.

In another exemplary embodiment, the process can include co-spraying a suspension and a dry powder. In this embodiment the dry powder particles have a larger size than the particles in the suspension to facilitate feeding the materials. This method can use different particle sizes at injection to form a coating with a composite of different splat sizes and/or morphologies. The suspension and dry injections can further be of different materials to also vary chemistry in the coating. Dry injection can use powders down to ˜5 microns. In another embodiment, the dry injection can use powders down to an average size of 20-50 microns.

Within the process of co-spraying a suspension and a dry powder, the thickness of individual layers or degree of mixing can be changed by changing the injection rate of both dry powder and suspension and the particle size of each. The morphology of one material's splats may be varied from the other material by selecting materials with significantly different melting points or significantly different particle sizes and tailoring the plasma parameters to only one of these materials. This could mean that one material forms typical splats as shown in these examples but the other material does not undergo significant melting and retains near its original particle shape.

The exemplary method is advantageous because the first layer may be applied via suspension plasma spray (SPS). SPS enables a mixture of dissimilar compositions on a fine scale that form a coating composition of multi-component ceramics because it relies on melting/softening of the ceramic and not vaporization during the transport to the substrate.

The use of YSZ and a higher Gd content GdZ or Gd₂O₃ material as the second phase and the use of sufficient YSZ to make a continuous matrix will increase the total toughness of the coating while the high Gd second material will provide the beneficial reaction with the CMAS.

Increased toughness is beneficial in other areas (e.g. erosion, handling) beyond just CMAS. Interconnected YSZ phase will likely increase thermal conductivity since low and high RE (rare earth) content fluorite has been shown to have near similar conductivity.

There has been provided a ceramic coating system and process. While the ceramic coating system and process have been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A ceramic coating process comprising:
introducing a suspension including a fine ceramic particulate suspended in a liquid carrier into a plasma torch, comprising at least one of co-spraying at least two suspensions composed of dissimilar fine ceramic particulate at least one of simultaneously and in series; spraying a single suspension composed of dissimilar fine ceramic particulate, and co-spraying at least one suspension composed of fine ceramic particulate and at least one dry powder into said plasma torch, wherein said dry powder is larger than said fine ceramic particulate, said fine ceramic particulate comprising a first material having high toughness and a second material having a beneficial reaction in combination with calcium-magnesium alumino-silicates;
forming at least one liquid droplet, the at least one liquid droplet comprising a plurality of said fine ceramic particulate wherein said fine ceramic particulate comprises a submicron size;
vaporizing the liquid carrier in said plasma; and
agglomerating said plurality of fine ceramic particulate into a single particulate;
melting said agglomerated fine ceramic particulate in said plasma torch;
propelling said melted fine ceramic particulate toward a substrate; and
forming a coating on said substrate, said coating comprising splats of said fine ceramic particulate.

2. The process according to claim 1, wherein said first material comprises YSZ and said second material comprises Gd₂Zr₂O₇.

3. The process according to claim 2, wherein said first material comprises at least one of a lanthanide series and Sc substituted partially or completely for Y.

4. The process according to claim 1, wherein said second material comprises 51-99 mol % GdO_{1.5} and balance ZrO₂.

5. The process according to claim 1, wherein said second material comprises Gd₂O₃.

6. The process according to claim 2, wherein said second material comprises at least one of any lanthanide series, Y, and Sc substituted partially or completely for Gd.

7. The process according to claim 2, wherein at least one of said first and said second material comprises at least one of Hf and Ti substituted at least partially or completely for Zr.

8. An article comprising:
a substrate having a surface; and
a coating system coupled to said surface, said coating system comprising a structure, said structure comprising a series of individual splats formed from agglomerated fine ceramic particulate, said agglomerated fine ceramic particulate consisting of a first material of YSZ and a second material of 20-100 mol % GdO_{1.5} balance ZrO₂, wherein said series of individual splats comprises at least one of similar fine ceramic particulate and at least two dissimilar fine ceramic and dry powder particles introduced from dry powders; wherein said dry powder particles are larger than said fine ceramic particulate.

9. The article according to claim 8, wherein said fine ceramic particulate includes a co-spray of a first suspension of YSZ and a second suspension of from about 20-70 mol % GdO_{1.5} balance ZrO₂.

10. The article according to claim 8, wherein said first material comprises at least one of a lanthanide series and Sc substituted partially or completely for Y.

11. The article according to claim 8, wherein said second material comprises 51-99 mol % GdO_{1.5} and balance ZrO₂.

12. The article according to claim 8, wherein said second material comprises Gd₂O₃.

13. The article according to claim 8, wherein said second material comprises at least one of any lanthanide series, Y, and Sc substituted partially or completely for Gd.

14. The article according to claim 8, wherein at least one of said first and said second material comprises at least one of Hf and Ti substituted at least partially or completely for Zr.

15. The article according to claim 8, wherein said structure comprises at least one of a porous structure, a dense structure having vertical cracks, a near fully dense structure, and a columnar structure.
